(19) United States
(12) Patent Application Publication
(10) Pub. No.: US 2026/0179359 A1
(43) Pub. Date: Jun. 25, 2026

(54) METHOD AND APPARATUS FOR IMAGE TRANSLATION USING DIFFUSION MODEL

(71) Applicant: Korea Advanced Institute of Science and Technology, Daejeon (KR)

(72) Inventors: MunChurl KIM, Daejeon (KR); JeongHyeok DO, Daejeon (KR)

(73) Assignee: Korea Advanced Institute of Science and Technology, Daejeon (KR)

(21) Appl. No.: 19/418,461

(22) Filed: Dec. 12, 2025

(30) Foreign Application Priority Data
Dec. 13, 2024 (KR) 10-2024-0186157
Dec. 9, 2025 (KR) 10-2025-0194334
Dec. 10, 2025 (KR) 10-2025-0195436

(51) Int. Cl. G06V 10/764; G06T 5/50; G06V 10/82

(52) U.S. Cl. CPC G06V 10/764; G06T 5/50; G06V 10/82

(57) ABSTRACT

A method and apparatus for translating an image using a diffusion model are provided. According to an embodiment, the method of translating a synthetic aperture radar (SAR) image into an electro-optical (EO) image based on additional conditioning data including map data that provides spatial information about a target region is provided.

### CROSS-REFERENCE TO RELATED APPLICATIONS

This application claims the benefit of priority under 35 U.S.C. § 119 to Republic of Korea Patent Application No. 10-2024-0186157, filed Dec. 13, 2024, Republic of Korea Patent Application No. 10-2025-0194334, filed Dec. 9, 2025, and Republic of Korea Patent Application No. 10-2025-0195436, filed Dec. 10, 2025, the contents of which are incorporated herein by reference in their entirety.

### TECHNICAL FIELD

The present disclosure relates to a method and apparatus for translating an image using a diffusion model.

### BACKGROUND

A satellite image technology may be used as a core technology in various fields, such as surveillance, disaster assessment, and environmental monitoring. The application may primarily rely on an optical image using an electro-optical sensor. An electro-optical (EO) image is easy to interpret intuitively because the EO image is similar to human visual perception but is significantly affected by weather conditions such as clouds, and at night, the EO image is difficult to capture or the quality thereof is significantly degraded.

On the other hand, since a synthetic aperture radar (SAR) generates an image by actively emitting radio waves and receiving a reflected signal, data may be stably obtained regardless of day or night and weather conditions. However, an SAR image includes speckle noise caused by radio-wave backscattering and may not provide fluent color or texture information like the EO image because of grayscale (intensity-based) representation characteristics. This may increase the interpretation complexity for a non-expert and may restrict the compatibility with a conventional analysis pipeline based on general visual information.

As research to overcome this restriction, an SAR-to-EO translation technology for improving the interpretation convenience and usability by translating an SAR image into a similar representation to an EO image has emerged.

The above information may be presented as the related art to help with the understanding of the disclosure. No arguments or decisions are raised as to whether any of the above description is applicable as the prior art related to the present disclosure.

### SUMMARY

According to an embodiment, a method of resolving an overfitting problem caused by a small synthetic aperture radar (SAR)-electro-optical (EO) dataset may be provided.

According to an embodiment, a training method that is robust to a spatial mismatch and/or a temporal mismatch between an SAR image and an EO image may be provided.

The technical goals of the present disclosure are not limited thereto.

According to an embodiment, a method of translating an image includes generating a synthetic aperture radar (SAR) latent feature by encoding an SAR image of a target region. The method includes generating an initial latent feature for denoising by adding noise to the SAR latent feature. The method includes generating an additional conditioning latent feature that provides structural guide information of the target region by encoding additional conditioning data including map data that provides spatial information about the target region. The method includes generating a first text latent feature by encoding first text information that provides at least one of temporal information of the SAR image and spatial information of the SAR image. The method includes generating a second text latent feature by encoding second text information describing that a type of an image to be generated from the SAR image is an electro-optical (EO) image type. The method includes generating an image description latent feature by encoding at least one of information related to the SAR image and information related to an EO image to be generated from the SAR image. The method includes generating an EO latent feature of the EO image by performing denoising on the initial latent feature using the SAR latent feature, the first text latent feature, the additional conditioning latent feature, the second text latent feature, and the image description latent feature. The method includes generating the EO image by decoding the EO latent feature.

The additional conditioning data further includes at least one of digital elevation model (DEM) data corresponding to the SAR image, digital surface model (DSM) data corresponding to the SAR image, and land cover map data corresponding to the SAR image.

The first text information is obtained by analyzing the SAR image using a vision-language model (VLM).

The generating of the EO latent feature includes performing the denoising on the initial latent feature based on a number of inference time steps indicating an iteration count of denoising tasks to be applied to generate the EO latent feature from the initial latent feature.

The performing of the denoising on the initial latent feature based on the number of inference time steps includes performing the denoising on the initial latent feature based on an inference time scheduler that determines a sequence of discrete time steps selected based on the number of inference time steps from pre-trained diffusion stages.

The information related to the SAR image includes at least one of capture condition information of the SAR image, a capture time of the SAR image, and pixel information of the SAR image. The pixel information of the SAR image includes at least one of a ground sample distance (GSD), latitude, and longitude of each pixel. The information related to the EO image includes at least one of style information of the EO image, a GSD of a pixel of the EO image, and temporal context information of the EO image.

According to an embodiment, an apparatus for translating an image includes at least one processor, and at least one memory storing instructions. The instructions, when executed individually or collectively by the at least one processor, cause the apparatus to perform a plurality of operations. The plurality of operations includes generating an SAR latent feature by encoding an SAR image of a target region. The plurality of operations includes generating an initial latent feature for denoising by adding noise to the SAR latent feature. The plurality of operations includes generating an additional conditioning latent feature that provides structural guide information of the target region by encoding additional conditioning data including map data that provides spatial information about the target region. The plurality of operations includes generating a first text latent feature by encoding first text information that provides at least one of temporal information of the SAR image and spatial information of the SAR image. The plurality of operations includes generating a second text latent feature by encoding second text information describing that a type of an image to be generated from the SAR image is an EO image type. The plurality of operations includes generating an image description latent feature by encoding at least one of information related to the SAR image and information related to an EO image to be generated from the SAR image. The plurality of operations includes generating an EO latent feature of the EO image by performing denoising on the initial latent feature using the SAR latent feature, the first text latent feature, the additional conditioning latent feature, the second text latent feature, and the image description latent feature. The plurality of operations includes generating the EO image by decoding the EO latent feature.

According to an embodiment, a method of training an image translation model includes generating an EO latent feature including feature information of an EO image that is a ground truth image by encoding the EO image. The method includes generating a noisy EO latent feature by adding noise to the EO latent feature. The method includes generating an SAR latent feature by encoding an SAR image corresponding to the EO image. The method includes generating an additional conditioning latent feature that provides structural guide information of a target region represented in the SAR image by encoding additional conditioning data including map data of the target region. The method includes generating a text latent feature by encoding a text prompt that provides at least one of temporal information of the SAR image and spatial information of the SAR image. The method includes, by using a denoising model, generating predicted noise corresponding to the noise, and a confidence map having a lower dimension than a dimension of the EO image based on the SAR latent feature, the noisy EO latent feature, the additional conditioning latent feature, and the text latent feature. The method includes updating parameters of the denoising model using the confidence map as a weight for an error between the noise and the predicted noise. The confidence map provides weighting information about at least one of a temporal mismatch and a spatial mismatch among the EO image, the SAR image, and the additional conditioning data.

The updating of the parameters of the denoising model includes updating the parameters so that the predicted noise becomes closer to the noise.

The updating of the parameters so that the predicted noise becomes close to the noise includes updating the parameters to minimize a value of a loss function for calculating a total loss corresponding to the confidence map using an individual loss of each pixel of the confidence map.

The generating of the predicted noise and the confidence map includes generating the predicted noise and the confidence map from the SAR latent feature, the noisy EO latent feature, the additional conditioning latent feature, and the text latent feature based on a time step that provides information about a level of the noise added to the EO latent feature.

### BRIEF DESCRIPTION OF THE DRAWINGS

FIG. 1 illustrates an image translation device according to various embodiments.

FIG. 2 illustrates an example of a temporal mismatch and a spatial mismatch between a synthetic aperture radar (SAR) image and an electro-optical (EO) image.

FIG. 3 illustrates an example of a training framework according to various embodiments.

FIG. 4 illustrates an example of an inference framework according to various embodiments.

FIG. 5 illustrates an example of an image translation method according to various embodiments.

FIG. 6 illustrates an example of image translation based on a multimodal condition according to various embodiments.

FIG. 7 illustrates an example of a training framework based on a multimodal condition according to various embodiments.

FIG. 8 illustrates an example of an inference framework based on a multimodal condition according to various embodiments.

FIG. 9 illustrates an example of an image translation method based on a multimodal condition according to various embodiments.

FIG. 10 is a block diagram of an example of a training apparatus according to various embodiments.

FIG. 11 illustrates a block diagram of an example of an image translation device according to various embodiments.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, the term “unit” is not limited to software or hardware. The “unit” may be configured to be in an addressable storage medium or configured to operate one or more processors. For example, the “unit” may include components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

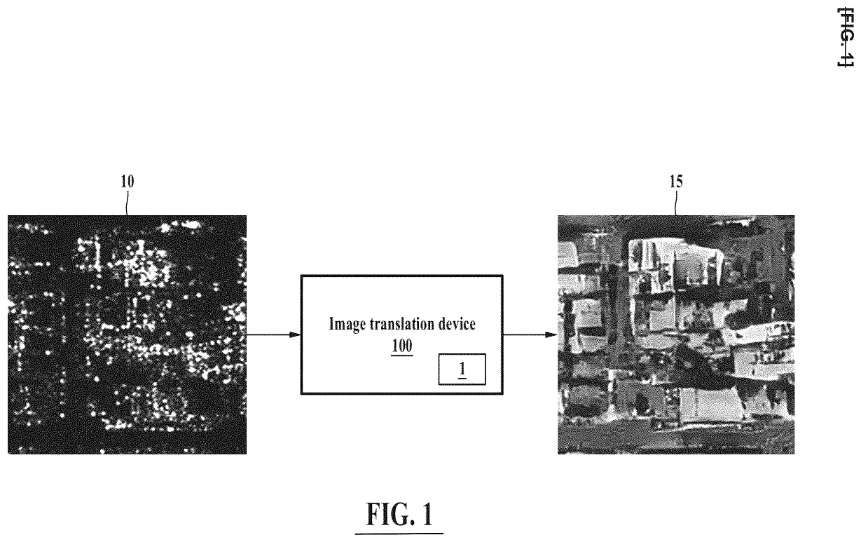

FIG. 1 illustrates an image translation device according to various embodiments.

Referring to FIG. 1, according to an embodiment, an image translation device 100 may translate a synthetic aperture radar (SAR) image 10 into an electro-optical (EO) image 15.

An SAR image 10 may be an image generated using a reflected signal of radar waves, wherein the reflected signal is emitted from an artificial satellite or aircraft toward the ground and then returns. The SAR image 10 may have the advantage of being suitable for observing the ground surface without being affected by weather conditions and/or time constraints.

The EO image 15 may be an image created by sensing reflected light using a sensor when the light from a light source is reflected on an object.

A method of translating the SAR image 10 into the EO image 15 may be a method of translating the SAR image 10 that is difficult to interpret into the EO image 15 that is easy to interpret while maintaining the advantage of the SAR image 10 that is captured without being affected by weather conditions or time constraints.

The image translation device 100 may translate an SAR image into the high-quality EO image 15 using a trained image translation model 1.

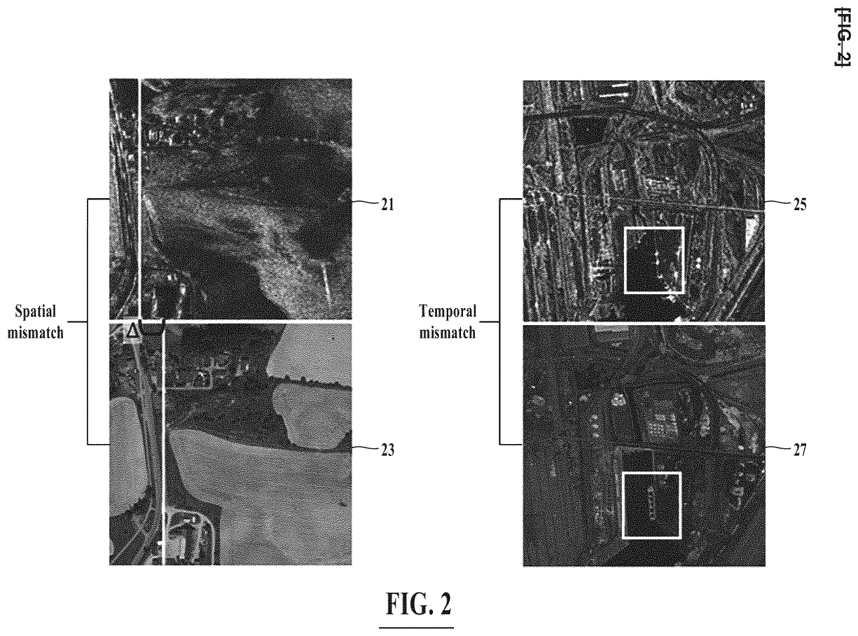

FIG. 2 illustrates an example of a temporal mismatch and a spatial mismatch between an SAR image and an EO image.

An SAR image and an EO image corresponding to the SAR image may be required to train the image translation model 1. Obtaining a large number of pairs of SAR images and EO images may be costly and labor-intensive. When training the image translation model 1 using a small number of pairs of SAR images and EO images, an overfitting problem may occur. According to an embodiment of the present disclosure, a latent diffusion model that is pre-trained using a large natural image dataset (e.g., LAION-5B) may be fine-tuned using a small number of pairs of SAR images and EO images.

However, as illustrated in FIG. 2, a temporal mismatch or spatial mismatch between an SAR image and an EO image may be present.

The spatial mismatch may refer to an event in which a geographical location captured in an SAR image 21 is slightly misaligned with a geographical location captured in an EO image 23 even though the same area is captured. The spatial mismatch may be caused by a difference in the orbits or altitudes of satellites used for image capturing or a difference between sensors.

The temporal mismatch may refer to a difference in image content caused by the difference in the capture time of an SAR image 25 and the capture time of an EO image 27. For example, even though the same area is captured, the EO image 27 may include an object that is not included in the SAR image 25.

The temporal mismatch and/or spatial mismatch may cause hallucination and/or an artifact of an image translation model. According to various embodiments of the present disclosure, an image translation method that is robust to a temporal mismatch and a spatial mismatch between an SAR image and an EO image may be provided.

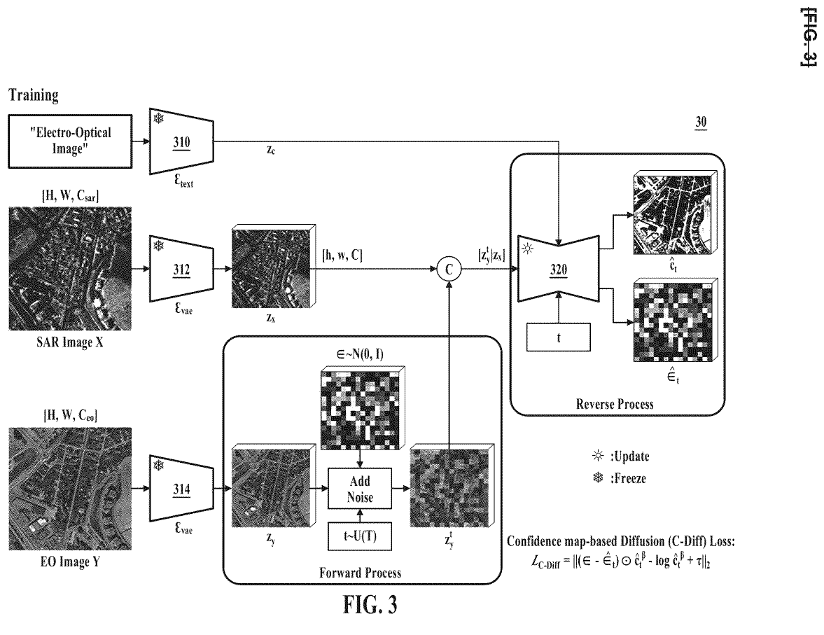

FIG. 3 illustrates an example of a training framework according to various embodiments.

Referring to FIG. 3, according to an embodiment, an image translation model (e.g., the image translation model 1 of FIG. 1) may include a latent diffusion model 30. The latent diffusion model 30 may be pre-trained by a large natural image dataset (e.g., LAION-5B). The overfitting problem described above may be mitigated using the pre-trained latent diffusion model 30.

The pre-trained latent diffusion model 30 may be additionally trained to make the pre-trained latent diffusion model 30 suitable for SAR image-to-EO image translation. An SAR-EO dataset as defined in Equation 1 may be used for additional training (e.g., fine-tuning) of the latent diffusion model 30.

$$𝒥 = \{ ( X , Y ) \} \qquad [ Equation 1 ]$$

In Equation 1, X∈ [symbol] ^{H×W×C}^{ₛₐᵣ} may denote an SAR image having a size of H×W and a channel of Cₛₐᵣ, and Y∈ [symbol] ^{H×W×C}^{ₑₒ} may denote an EO image having a size of H×W and a channel of Cₑₒ.

The image translation model may generate a reconstructed EO image Ŷ corresponding to an SAR image X via a training framework for additional training. The training framework may include an embedding process of an SAR image and an EO image into a latent space, a forward diffusion process, and a reverse diffusion process.

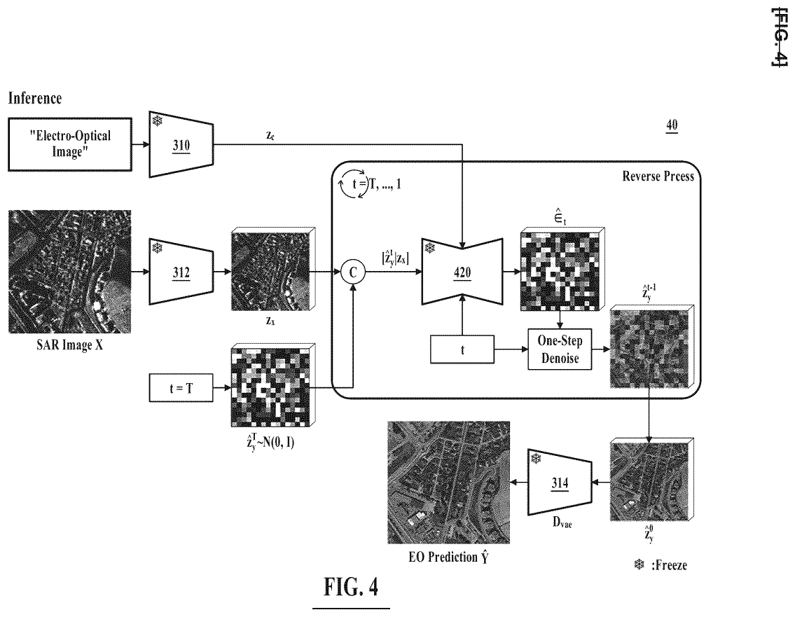

A pre-trained variational autoencoder (VAE) (e.g., an image encoder 312 and an image encoder 314) of the latent diffusion model 30 may be used to map (or embed) the SAR image X and the EO image Y to the latent space from a pixel space. The VAE may be frozen in a training process (e.g., a fine-tuning stage) and may function as an encoder εᵥₐₑ and a decoder (e.g., a decoder [symbol] ᵥₐₑ of FIG. 4) for an input image (e.g., the SAR image and/or the EO image). Since the latent diffusion model 30 is pre-trained by the large natural image dataset, the latent diffusion model 30 may be designed to receive a 3-channel red, green, and blue (RGB) image as an input.

Since an RGB band of the EO image Y is represented as a 3-channel input, the RGB band of the EO image Y may be transmitted to the VAE 314 without modification. The VAE 314 may preserve the content and/or structure of the EO image Y and may ensure a low reconstruction error ∥Y− [symbol] ᵥₐₑ(εᵥₐₑ(Y))∥₂. The low reconstruction error may indicate that the RGB band of the EO image Y has a significantly small domain gap compared to a natural RGB image.

Depending on a sensor of a satellite, the SAR image X may be a 1-channel (e.g., a horizontal-horizontal (HH) or vertical-vertical (VV) component) single-polarization SAR image or a 4-channel (e.g., HH, horizontal-vertical (HV), vertical-horizontal (VH), and VV components) full-polarization image. In the case of the 1-channel SAR image, a 3-channel input may be configured by duplicating a 1-channel image to meet an input requirement (e.g., a 3-channel image needs to be input) of the VAE 312. In the case of the 4-channel SAR image, a 3-channel input may be configured using HH and VV components and a mean between HV and VH to meet the input requirement of the VAE 312. For an input translated to meet the input requirement of the VAE 312, the VAE 312 may ensure the low reconstruction error ∥X− [symbol] ᵥₐₑ(εᵥₐₑ(X))∥₂.

The VAEs 312 and 314 of the latent diffusion model 30 that is trained by the large natural image dataset may embed the SAR image X and the EO image Y into the same latent space. Accordingly, an SAR feature may be used as a conditioning input and may ensure that pixel-wise correspondence between an SAR latent space and an EO latent space is maintained in a process of generating the EO image.

Via the VAE 312 or 314, the SAR image X or the EO image Y may be compressed into a small latent space having a relatively low dimension compared to original data (e.g., the SAR image X and/or the EO image Y), and as described below, as denoising is performed in a low-dimensional small latent space, the influence of the spatial mismatch between the SAR image X and the EO image Y may be significantly reduced.

During the forward diffusion process, noise may be gradually added to a target EO feature. According to a denoising diffusion probabilistic models (DDPMs) framework, the noise may be added to a target EO feature z_{y} across a sequence t˜ [symbol] (T) of time steps. [symbol] may be a uniform distribution, and T may be a total number of time steps. For example, at each time step t, a noisy EO feature

$${z}_{y}^{t}$$

may be generated through downsampling as Equation 2.

$${z}_{y}^{t} = \sqrt{{\overline{α}}_{t}} {z}_{y} + \sqrt{1 - {\overline{α}}_{t}} ϵ , ϵ ∼ 𝒩 ( 0 , I ) \qquad [ Equation 2 ]$$

In Equation 2, [symbol] may be a Gaussian distribution, ϵ∈ [symbol] ^{h×w×C} may be satisfied, and

$${\overline{α}}_{t} = {\prod }_{s = 1}^{t} ( 1 - {β}_{s} )$$

may determine the size of noise at each time step t.

A denoising model 320 (e.g., denoising U-Net) may learn the reverse diffusion process by predicting the noise added to the target EO feature. For example, as described below, a parameter (e.g., a weight and/or a bias) of the denoising model 320 may be updated based on a confidence-guided diffusion loss function of Equation 5.

A fixed prompt p=“electro-optical image” may be used as a stable conditioning signal to utilize a text-to-image translation ability of the pre-trained latent diffusion model 30 and provide strong initialization. A text encoder 310 (e.g., a contrastive language-image pre-training (CLIP) text encoder) may embed a prompt p as Equation 3. Compared to a null prompt, the prompt p may allow the latent diffusion model 30 to focus on an EO feature. For example, the prompt p may be text that informs the latent diffusion model 30 that the latent diffusion model 30 needs to generate an output having an EO image style rather than real image data.

$${z}_{c} = {ℰ}_{text} ( p ) \qquad [ Equation 3 ]$$

In Equation 3, z_{c} may denote text prompt embedding, εₜₑₓₜ may denote the text encoder 310, and p may denote a prompt.

The denoising model 320 may receive a conditioning SAR feature zₓ concatenated with a noisy EO feature

$${z}_{y}^{t}$$

along a channel dimension as an input and may also receive a time step t and the text prompt embedding z_{c}. As described above, the time step t may provide the denoising model 320 with a level of noise included in the noisy EO feature

$${z}_{y}^{t} ,$$

and the text prompt embedding z_{c} may inform the denoising model 320 that an image to be generated is an EO image.

The denoising model 320 may output a confidence map [symbol] that provides information about predicted noise et and pixel-wise uncertainty as Equation 4. The confidence map [symbol] may provide information about the accuracy of noise prediction for each pixel. For example, pixels of a confidence map corresponding to an area in which a temporal mismatch between an SAR image X and an EO image Y is present may have a relatively low confidence value. For example, when the SAR image X includes an object (e.g., a vehicle) and the EO image Y does not include the object, pixels of a confidence map corresponding to an image area of the object may have a relatively low confidence value.

$$[ \hat{{ϵ}_{t}} \vert \hat{{c}_{t}} ] = ψ ( [ {z}_{y}^{t} \vert {z}_{x} ] , {z}_{c} , t ) \qquad [ Equation 4 ]$$

In Equation 4, ψ may denote the denoising model 320, and [⋅|⋅] may denote channel-wise concatenation. A confidence map [symbol] may be additionally processed using a SoftPlus operation so that all values are non-negative.

According to an embodiment, a confidence-guided diffusion loss function [symbol] _{C-Diff} may be used to resolve the temporal mismatch between an SAR image X and an EO image Y. The confidence-guided diffusion loss function [symbol] _{C-Diff} may use the confidence map [symbol] as a weight to calculate an error (e.g., the difference between original noise and predicted noise) of the denoising model 320. The confidence-guided diffusion loss function [symbol] _{C-Diff} may assign a pixel-wise adaptive weight to predicted noise [symbol] . The confidence-guided diffusion loss function [symbol] _{C-Diff} may be designed to assign a relatively high weight to a region (e.g., a pixel) with high confidence and assign a relatively low weight to a region with low confidence, thereby improving robustness in an area (e.g., a pixel) in which the temporal mismatch is present. The confidence-guided diffusion loss function [symbol] _{C-Diff} may optimize the denoising model 320 by concatenating a regularization term of the confidence map [symbol] with a pixel-wise reconstruction loss to which the weight is applied. The confidence-guided diffusion loss function [symbol] _{C-Diff} may be represented as Equation 5.

$${ℒ}_{C - Diff} = {‖ ( ϵ - {\hat{ϵ}}_{t} ) ⊙ = {\hat{c}}_{t}^{β} - log {\hat{c}}_{t}^{β} + τ ‖}_{2} \qquad [ Equation 5 ]$$

In Equation 5, a regularization term

$$- log {\hat{c}}_{t}^{β}$$

may prevent the denoising model 320 from making confidence values of all pixels lower than a predetermined value (e.g., 0) regardless of a temporal mismatch between an SAR image X and an EO image Y. τ may be a margin term for ensuring that the confidence-guided diffusion loss function [symbol] _{C-Diff} does not become negative. [symbol] may act as an adaptive weighting factor to allow the denoising model 320 to focus on a well-aligned region (e.g., a region with high confidence) and reduce the penalty in an uncertain region (e.g., a region with low confidence). A log term may act as a normalizer to prevent [symbol] from converging to 0. β may be experimentally determined. For example, the denoising model 320 may achieve the highest performance when β is 1, and when β is 0, the confidence-guided diffusion loss function [symbol] _{C-Diff} may be a standard [symbol] ₂ (mean squared error (MSE)) loss without an adaptive weight. The confidence-guided diffusion loss function [symbol] _{C-Diff} may allow the latent diffusion model 30 to mitigate an artifact and hallucination that may occur in a temporally coincident region and generate an EO image having high structural accuracy.

FIG. 4 illustrates an example of an inference framework according to various embodiments.

Referring to FIG. 4, according to an embodiment, a latent diffusion model 40 that is additionally trained (e.g., fine-tuned) via the training framework illustrated in FIG. 3 may generate a reconstructed EO image Ŷ corresponding to an SAR image X in an inference process.

The latent diffusion model 40 may obtain SAR latent code (or a compressed feature) zₓ=εᵥₐₑ(X) by inputting the SAR image X (e.g., an unseen SAR image) to the VAE 312. The SAR latent code zₓ may include information (e.g., the structure and/or shape) about the SAR image X and may be used as conditioning information (e.g., guidance information) to generate the reconstructed EO image Ŷ corresponding to the SAR image X in a reverse diffusion process of the inference process.

During the inference process, a denoising model 420 (e.g., a fine-tuned denoising model) may iteratively refine noisy latent code

$${\hat{z}}_{y}^{t} .$$

For example, the denoising model 420 may reconstruct target latent code

$${z}_{y}^{0} = {z}_{y}$$

by removing noise [symbol] predicted from the noisy latent code

$${\hat{z}}_{y}^{t} .$$

Starting from pure noise

$${\hat{z}}_{y}^{t} ,$$

the denoising model 420 may iteratively refine noisy EO latent code

$${\hat{z}}_{y}^{t}$$

by predicting noise [symbol] that needs to be removed at each time step t as Equation 6.

$$[ \vert Dummy ] = ψ ( [ \vert {z}_{x} ] , {z}_{c} , t ) \qquad [ Equation 6 ]$$

In Equation 6, ψ may denote the denoising model 420, and Dummy may denote a dummy confidence value (e.g., a confidence map). Since the denoising model 420 is trained to simultaneously output the predicted noise [symbol] and the confidence map (e.g., the confidence map [symbol] of FIG. 3), in the inference process, the denoising model 420 may output not only the predicted noise [symbol] but also the confidence map. However, since the confidence map is not used in the inference process, the confidence map may be represented as “Dummy”. The predicted noise [symbol] may be used to calculate

$${\hat{z}}_{y}^{t - 1}$$

in the reverse diffusing process in the interference process. The predicted noise Et may be used to gradually remove noise of EO latent code until

$${\hat{z}}_{y}^{t - 1}$$

converges to the target latent code. As Equation 7, final latent code

$${\hat{z}}_{y}^{0}$$

may be input to the VAL 314 (e.g., a decoder of the VAE), and the VAE 314 may generate a reconstructed (or predicted) EO image Ŷ.

In Equation 6,

$${\hat{z}}_{y}^{t}$$

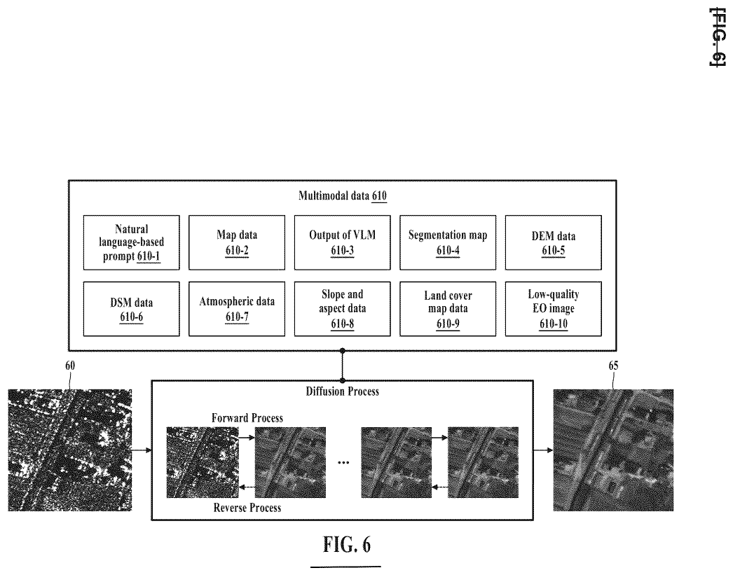

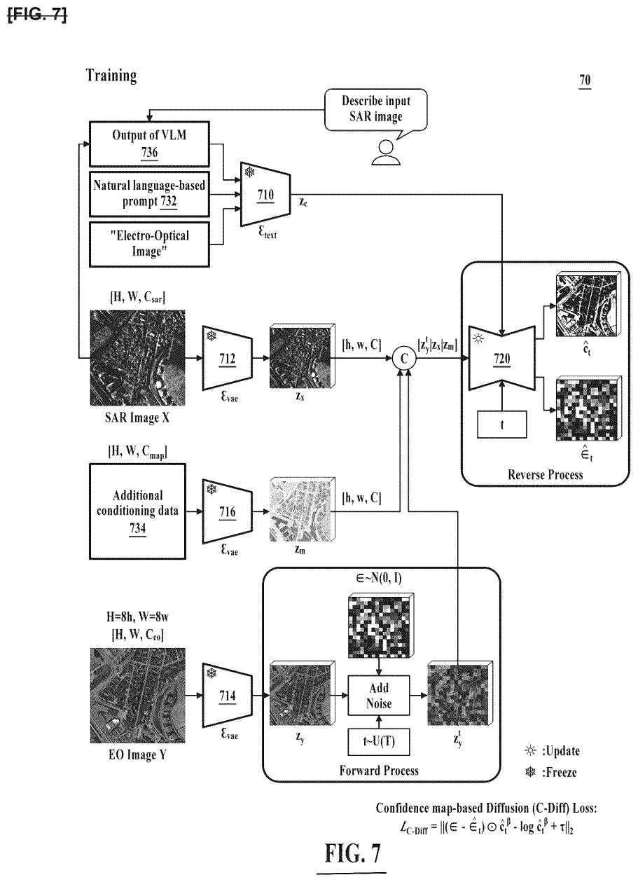

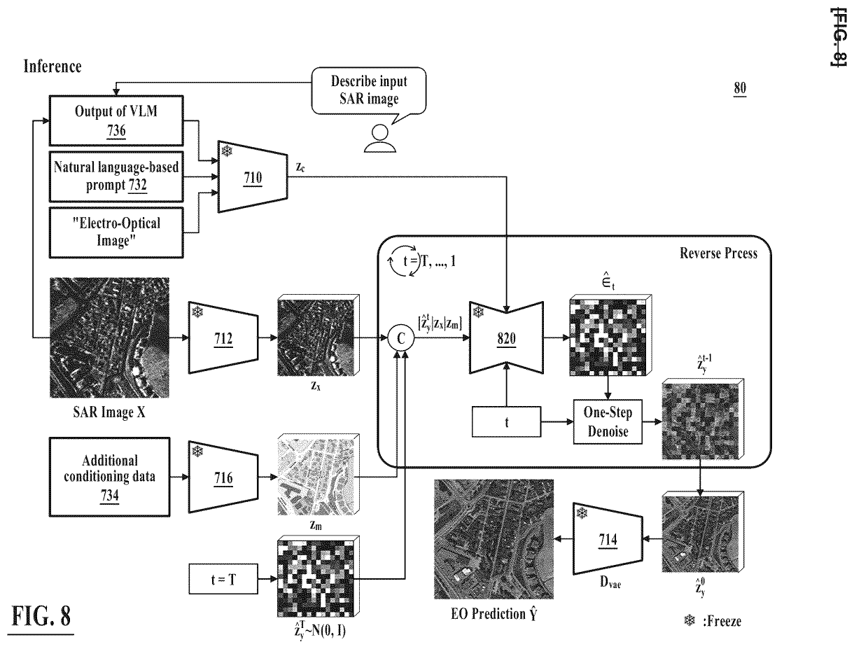

may denote noisy EO latent code, but when additional conditioning data 734 (e.g., digital elevation model (DEM) data corresponding to an SAR image, digital surface model (DSM) data corresponding to the SAR image, land cover map data corresponding to the SAR image, slope data corresponding to the SAR image, and/or atmospheric data corresponding to the SAR image) described with reference to FIG. 6 or 7 is used as an input, the additional conditioning data may be encoded into latent code (e.g., latent code zₘ of FIG. 8), and the latent code of the additional conditioning data may be concatenated with the noisy EO latent code

$${\hat{z}}_{y}^{t} ,$$

thereby generating a single piece of integrated latent code.

$$\hat{Y} = {𝒟}_{v a e} ( {\hat{z}}_{y}^{0} ) \qquad [ Equation 7 ]$$

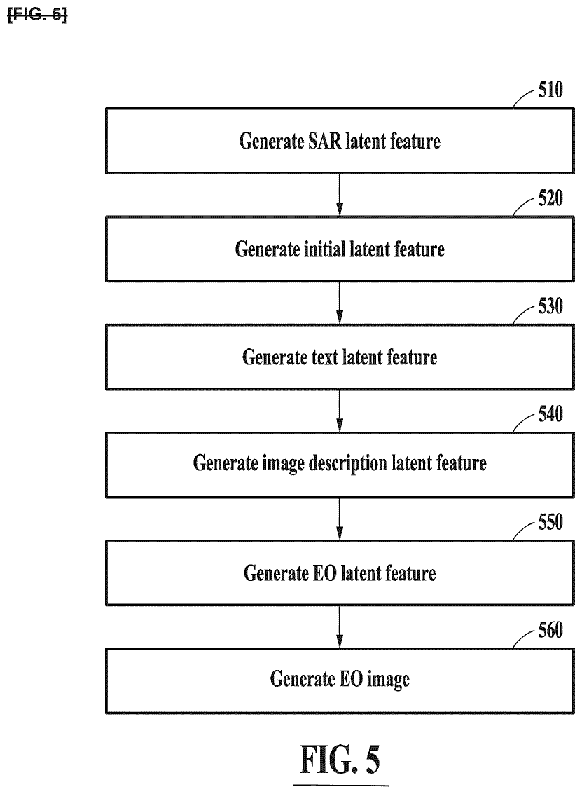

FIG. 5 illustrates an example of an image translation method according to various embodiments.

Referring to FIG. 5, according to an embodiment, a method of translating an SAR image into an EO image using a trained image translation model may be provided.

In operation 510, an electronic device (e.g., the image translation device) may generate an SAR latent feature by encoding an SAR image. For example, the electronic device may encode the SAR image using a pre-trained encoder (e.g., the VAE). For example, the pre-trained encoder may be included in an image translation model. An SAR latent feature may have a lower dimension than the SAR image.

In operation 520, the electronic device may generate an initial latent feature for denoising by adding (e.g., concatenating) noise to the SAR latent feature. The initial latent feature may be data that serves as a starting point in a reverse diffusion process of a diffusion model.

In operation 530, the electronic device may a generate text latent feature by encoding a text prompt (e.g., the prompt p of Equation 3) describing that a type of an image to be generated by the image translation model from the SAR image is an EO image type. For example, the electronic device may encode the text prompt using a pre-trained text encoder (e.g., a pre-trained CLIP text encoder).

In operation 540, the electronic device may generate an image description latent feature by encoding at least one of information related to the SAR image and information related to an EO image. For example, the electronic device may encode the information related to the SAR image and/or the information related to the EO image using the pre-trained text encoder.

The information related to the SAR image may be information provided to the image translation model to help the image translation model accurately understand the SAR image. For example, the information related to the SAR image may include at least one of information related to a capture condition of the SAR image (e.g., information about a satellite that captures the SAR image and/or the orbit of the satellite), a time point at which the SAR image is captured (e.g., season and/or time), pixel information (e.g., a ground sample distance (GSD), latitude, and/or longitude), and text describing the SAR image. The text describing the SAR image may be generated by a vision-language model (VLM) or a human.

The information related to the EO image may provide detailed guidance information about the EO image to be generated by the image translation model. For example, the information related to the EO image may include at least one of style information of the EO image (e.g., sensor information or art style information, such as “make it in the Google Earth style”), pixel information (e.g., the GSD), and temporal context information (e.g., text describing the temporal context of the EO image, such as “represent as an image captured in the summer”).

According to an embodiment, as the image description latent feature is provided to an image translation model, the image translation model may precisely translate the SAR image into an EO image that a user desires.

In operation 550, the electronic device may generate an EO latent feature of the EO image by performing denoising on the initial latent feature based on the text latent feature and the image description latent feature. The text latent feature and/or the image description latent feature may be used as conditioning information during a denoising process. The electronic device may generate the EO latent feature by gradually (or iteratively) removing noise from the initial latent feature based on the number of inference time steps and an inference time scheduler. The electronic device may use a denoising model for denoising. For example, the denoising model may be included in the image translation model.

The number of inference time steps may be a count of denoising tasks performed to generate the EO latent feature from the initial latent feature. For example, the number of inference time steps may be set so that fewer denoising tasks are performed than training processes during the inference process. For example, when 100 time steps are applied to the training process, the number of inference time steps may be set to a number less than 100 (e.g., 10).

The inference time scheduler may determine a sequence of discrete time steps selected based on the number of inference time steps. For example, when 100 time steps are applied to the training process and the number of inference time steps is set to 10, the inference time scheduler may determine 10 time steps to be used for inference from 100 time steps.

In operation 560, the electronic device may generate the EO image by decoding the EO latent feature. The electronic device may use a pre-trained decoder (e.g., a decoder of the VAE) to decode the EO latent feature. The EO latent feature in a low-dimensional latent space may be translated into the EO image in a high-dimensional (or high-resolution) pixel space through decoding.

FIG. 6 illustrates an example of image translation based on a multimodal condition according to various embodiments.

Referring to FIG. 6, according to an embodiment, multimodal data (or a multimodal condition) 610 may be used as input data to translate an SAR image 60 into an EO image 65. The multimodal data 610 may be used as conditioning information (or condition information) of denoising in a diffusion process to translate the SAR image 60 into the EO image 65.

For example, a natural language-based prompt 610-1 may be used as the conditioning information to translate the SAR image 60 into the EO image 65. The natural language-based prompt 610-1 may provide at least one of temporal information and spatial information of the SAR image 60. For example, the natural language-based prompt 610-1 may provide the latitude and longitude of a region represented in (or corresponding to) the SAR image 60. For example, the natural language-based prompt 610-1 may provide a time of day, season, and/or weather when the SAR image 60 is captured.

For example, map data 610-2 (e.g., high-definition map data) of the region represented in (or corresponding to) the SAR image 60 may be used as the conditioning information to translate the SAR image 60 into the EO image 65. For example, the map data may be vector data extracted from a geographic information system (GIS) database or OpenStreetMap, and/or may be image data generated by rasterizing the vector data. In the diffusion process, the map data 610-2 may provide a structural guideline of the region represented in (or corresponding to) the SAR image 60. The map data 610-2 may help reduce hallucination of the image translation model.

For example, an output 610-3 of a VLM may be used as the conditioning information to translate the SAR image 60 into the EO image 65. An output 610-3 of the VLM may be text information (e.g., “this area is a residential area” or “this area is an industrial complex”) that describes at least one of temporal information or spatial information of the region represented in (or corresponding to) the SAR image 60. The SAR image 60 and/or a low-quality EO image (e.g., an EO image captured at night or in bad weather) that represents the same region as the SAR image 60 may be used as input data to the VLM to generate the text information. The output 610-3 of the VLM may help accurately reflect the texture and/or details of the region represented in (or corresponding to) the SAR image 60 in the EO image 65.

For example, a segmentation map 610-4 (e.g., a semantic segmentation map and/or instance segmentation map) of the SAR image 60 may be used as conditioning information to translate the SAR image 60 into the EO image 65.

For example, DEM data 610-5 of the region represented in (or corresponding to) the SAR image 60 may be used as the conditioning information to translate the SAR image 60 into the EO image 65. The DEM data 610-5 may provide height information of the ground surface of the region represented in (or corresponding to) the SAR image 60.

For example, DSM data 610-6 of the region represented in (or corresponding to) the SAR image 60 may be used as conditioning information to translate the SAR image 60 into the EO image 65. The DSM data 610-6 may provide information (e.g., location information and/or height information) related to terrain, an artificial structure, and/or a natural object of the region represented in (or corresponding to) the SAR image 60.

For example, atmospheric data 610-7 may be used as the conditioning information to translate the SAR image 60 into the EO image 65. The atmospheric data 610-7 may provide information about an atmospheric state of the region represented in (or corresponding to) the SAR image 60 at a time point when the SAR image 60 is captured.

For example, slope and aspect data 610-8 may be used as the conditioning information to translate the SAR image 60 into the EO image 65. The slope and aspect data 610-8 may provide information about the slope and aspect of the ground of the region represented in (or corresponding to) the SAR image 60.

For example, land cover map data 610-9 may be used as the conditioning information to translate the SAR image 60 into the EO image 65. The land cover map data 610-9 may provide information about a type of substance (e.g., grass, a tree, a building, and/or water) that covers the ground surface of the region represented in (or corresponding to) the SAR image 60.

For example, a low-quality EO image 610-10 may be used as the conditioning information to translate the SAR image 60 into the EO image 65. The low-quality EO image 610-10 may be an EO image capturing the region represented in (or corresponding to) the SAR image 60. The quality of the low-quality EO image 610-10 may be lower than the quality of the EO image 65. For example, the low-quality EO image 610-10 may be captured during a time of day or in a weather environment (e.g., night or in bad weather) having an adverse influence on the quality of the EO image.

FIG. 7 illustrates an example of a training framework based on a multimodal condition according to various embodiments.

Referring to FIG. 7, according to an embodiment, a pre-trained latent diffusion model 70 may be additionally trained using multimodal data (e.g., the multimodal data 610 of FIG. 6). A repeated description of the training process of the pre-trained latent diffusion model 30 described with reference to FIG. 3 is omitted.

A text encoder 710 may generate text prompt embedding z_{c} from a fixed prompt p=“electro-optical image”, a natural language-based prompt 732 (e.g., the natural language-based prompt 610-1 of FIG. 6), and/or an output 736 of a VLM (e.g., the output 610-3 of the VLM of FIG. 6).

A VAE 712 (e.g., the VAE 312 of FIG. 3) may generate an SAR latent feature zₓ by encoding an SAR image X into a latent space.

A VAE 714 (e.g., the VAE 314 of FIG. 3) may generate an EO latent feature z_{y} by encoding an EO image Y into the latent space.

A VAE 716 may generate a latent feature zₘ of additional conditioning data 734 by encoding the additional conditioning data 734 that provides at least one of temporal information and spatial information of a region represented in (or corresponding to) the SAR image X. The additional conditioning data 734 may include at least one of the map data 610-2, the output 610-3 of the VLM, the segmentation map 610-4, the DEM data 610-5, the DSM data 610-6, the atmospheric data 610-7, the slope and aspect data 610-8, the land cover map data 610-9, and the low-quality EO image 610-10 of FIG. 6.

The SAR latent feature zₓ, a noisy EO feature

$${z}_{y}^{t} ,$$

and the latent feature zₘ of the additional conditioning data 734 may be input to a denoising model 820 (e.g., the denoising model 320 of FIG. 3).

The denoising model 720 may output a confidence map [symbol] that provides information about predicted noise [symbol] and pixel-wise uncertainty.

FIG. 8 illustrates an example of an inference framework based on a multimodal condition according to various embodiments.

Referring to FIG. 8, a latent diffusion model 80 that is additionally trained (e.g., fine-tuned) via the training framework illustrated in FIG. 7 may generate a reconstructed EO image Ŷ corresponding to an SAR image X in an inference process. A repeated description of the inference process of the latent diffusion model 40 described with reference to FIG. 4 is omitted.

The latent feature zₘ of the additional conditioning data 734 may be used as conditioning information (e.g., guidance information) to generate the reconstructed EO image Ŷ corresponding to the SAR image X in a reverse diffusion process of the inference process.

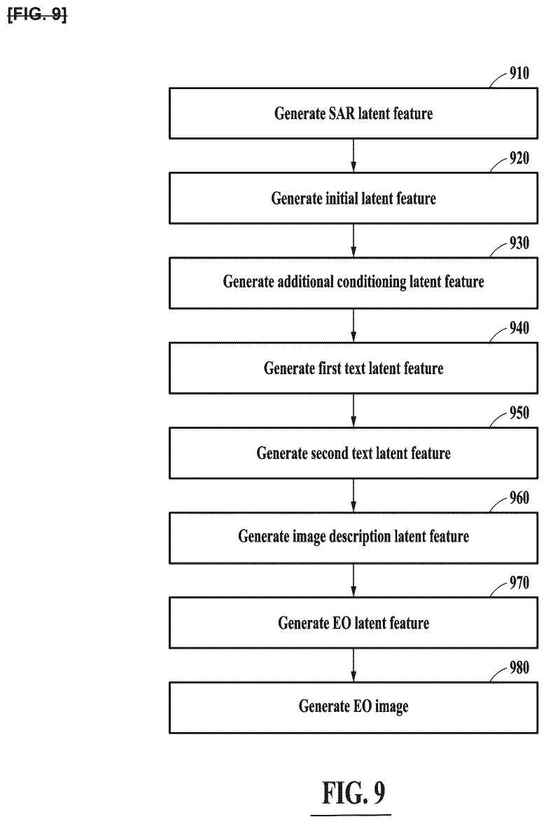

FIG. 9 illustrates an example of an image translation method based on a multimodal condition according to various embodiments.

Referring to FIG. 9, according to an embodiment, a method (e.g., an inference method) of translating an SAR image into an EO image using an image translation model (e.g., the latent diffusion model 80 of FIG. 8) that is trained based on a multimodal condition may be provided.

In operation 910, an electronic device (e.g., the image translation device) may generate an SAR latent feature by encoding an SAR image of a target region. For example, the electronic device may encode the SAR image using a pre-trained encoder (e.g., the VAE encoder). For example, the pre-trained encoder may be included in an image translation model. An SAR latent feature may have a lower dimension than the SAR image.

In operation 920, the electronic device may generate an initial latent feature for denoising by adding (e.g., concatenating) noise to the SAR latent feature. The initial latent feature may be data that serves as a starting point in a reverse diffusion process of a diffusion model.

In operation 930, the electronic device may generate an additional conditioning latent feature that provides structural guide information of the target region by encoding additional conditioning data including map data (e.g., the map data 610-2 of FIG. 6) that provides spatial information about the target region represented by the SAR image. The additional conditioning data may further include a segmentation map (e.g., the segmentation map 610-4 of FIG. 6) corresponding to the SAR image, DEM data (e.g., the DEM data 610-5 of FIG. 6) corresponding to the SAR image, DSM data (e.g., the DSM data 610-6 of FIG. 6) corresponding to the SAR image, atmospheric data (e.g., the atmospheric data 610-7 of FIG. 6) corresponding to the SAR image, slope and aspect data (e.g., the slope and aspect data 610-8 of FIG. 6) corresponding to the SAR image, land cover map data (e.g., the land cover map data 610-9 of FIG. 6) corresponding to the SAR image, and a low-quality EO image (e.g., the low-quality EO image 610-10 of FIG. 6) corresponding to the SAR image.

In operation 940, the electronic device may generate a first text latent feature by encoding first text information (e.g., the natural language-based prompt 732 or the output 736 of the VLM of FIG. 7 or 8) that provides at least one of temporal information of the SAR image or spatial information of the SAR image.

In operation 950, the electronic device may generate a second text latent feature by encoding second text information (e.g., the prompt p of FIG. 3) describing that a type of an image to be generated from the SAR image is an EO image type.

In operation 960, the electronic device may generate an image description latent feature by encoding at least one of information related to the SAR image and information related to an EO image. For example, the electronic device may encode the information related to the SAR image and/or the information related to the EO image using the pre-trained text encoder.

The information related to the SAR image may be information provided to the image translation model to help the image translation model accurately understand the SAR image. For example, the information related to the SAR image may include at least one of information related to a capture condition of the SAR image (e.g., information about a satellite that captures the SAR image and/or the orbit of the satellite), a time point at which the SAR image is captured (e.g., season and/or time), pixel information (e.g., a GSD, latitude, and/or longitude), and text describing the SAR image. The text describing the SAR image may be generated by a VLM or human.

The information related to the EO image may provide detailed guidance information about the EO image to be generated by the image translation model. For example, the information related to the EO image may include at least one of style information of the EO image (e.g., sensor information or art style information, such as “make it in the Google Earth style”), pixel information (e.g., the GSD), and temporal context information (e.g., text describing the temporal context of the EO image, such as “represent as an image captured in the summer”).

According to an embodiment, as an image description feature is provided to an image translation model, the image translation model may precisely translate the SAR image into an EO image that a user desires.

In operation 970, the electronic device may generate an EO latent feature of the EO image by performing denoising on the initial latent feature using the SAR latent feature, the first text latent feature, the additional conditioning latent feature, the second text latent feature, and the image description latent feature. Each of the SAR latent feature, the first text latent feature, the additional conditioning latent feature, the second text latent feature, and the image description latent feature may be used as the conditioning information for denoising. The electronic device may generate the EO latent feature by gradually (or iteratively) removing noise from the initial latent feature based on the number of inference time steps and an inference time scheduler. The electronic device may use a denoising model for denoising. For example, the denoising model may be included in the image translation model.

The number of inference time steps may be a count of denoising tasks performed to generate the EO latent feature from the initial latent feature. For example, the number of inference time steps may be set so that fewer denoising tasks are performed than training processes during the inference process. For example, when 100 time steps are applied to the training process, the number of inference time steps may be set to a number less than 100 (e.g., 10).

The inference time scheduler may determine a sequence of discrete time steps selected based on the number of inference time steps. For example, when 100 time steps are applied to the training process and the number of inference time steps is set to 10, the inference time scheduler may determine 10 time steps to be used for inference from 100 time steps.

In operation 980, the electronic device may generate the EO image by decoding the EO latent feature. The electronic device may use a pre-trained decoder (e.g., a decoder of the VAE) to decode the EO latent feature. The EO latent feature in a low-dimensional latent space may be translated into the EO image in a high-dimensional (or high-resolution) pixel space through decoding.

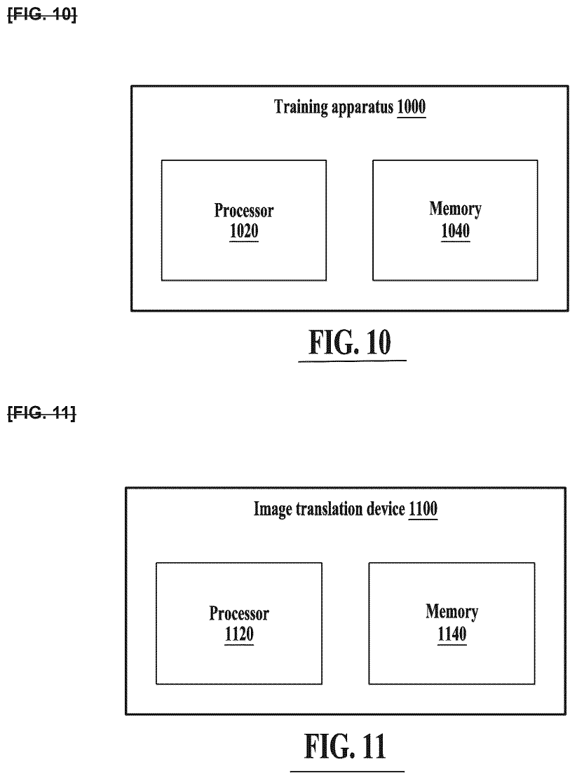

FIG. 10 is a block diagram of an example of a training apparatus according to various embodiments.

Referring to FIG. 10, according to an embodiment, a training apparatus 1000 (e.g., a server) may include at least one processor 1020 and a memory 1040.

The memory 1040 may store instructions (or programs) executable by the at least one processor 1020. For example, the instructions include instructions for performing an operation of the at least one processor 1020 and/or an operation of each component of the at least one processor 1020.

The memory 1040 may include one or more computer-readable storage media. The memory 1040 may include non-volatile storage elements (e.g., a solid state drive (SSD), a magnetic hard disk, an optical disk, a floppy disk, flash memory, electrically programmable memory (EPROM), and electrically erasable and programmable memory (EEPROM)).

The memory 1040 may be a non-transitory medium. The term “non-transitory” may indicate that the storage medium is not embodied in a carrier wave or a propagated signal. However, the term “non-transitory” shall not be interpreted that the memory 1040 is non-movable.

The at least one processor 1020 may process data stored in the memory 1040. The at least one processor 1020 may execute computer-readable code (e.g., software) stored in the memory 1040 and instructions triggered by the at least one processor 1020.

The at least one processor 1020 may be a data processing device implemented as hardware including a circuit having a physical structure to perform desired operations. For example, the desired operations may include code or instructions included in a program.

For example, the hardware-implemented data processing device may include a microprocessor, a CPU, a processor core, a multi-core processor, a multiprocessor, an ASIC, or an FPGA.

The at least one processor 1020 may include a variety of processing circuitry and/or a plurality of processors. For example, as used in the present disclosure and claims, the term “processor” may include a variety of processing circuitry including at least one processor, and one or more of the at least one processor may be configured to individually or collectively perform various functions described herein. When the present disclosure describes that the “processor”, “at least one processor”, or “one or more processors” are configured to perform various functions, these terms may include, for example, a case in which one processor performs some of the described functions and the other processors perform other functions, as well as a case in which a single processor performs all of the described functions. The at least one processor may be a combination of processors for performing the described or disclosed functions collectively. The at least one processor may execute a program instruction to achieve or perform various functions.

For example, the at least one processor 1020 may include a main processor (e.g., a CPU or an application processor) and an auxiliary processor (e.g., a communication processor, a neural processing unit (NPU), and/or a graphics processing unit (GPU)).

The at least one processor 1020 may cause the training apparatus 1000 to perform operations performed during the training process or the inference process described herein by individually or collectively executing the code, instructions, and/or applications stored in the memory 1040.

FIG. 11 illustrates a block diagram of an example of an image translation device according to various embodiments.

Referring to FIG. 11, according to an embodiment, an image translation device 1100 (e.g., an electronic device, such as a smartphone, a tablet, a personal computer (PC), or a laptop) may include at least one processor 1120 and a memory 1140.

The memory 1140 may store instructions (or programs) executable by the at least one processor 1120. For example, the instructions include instructions for performing an operation of the at least one processor 1120 and/or an operation of each component of the at least one processor 1120.

The memory 1140 may include one or more computer-readable storage media. The memory 1140 may include non-volatile storage elements (e.g., an SSD, a magnetic hard disk, an optical disk, a floppy disk, flash memory, EPROM, and EEPROM).

The memory 1140 may be a non-transitory medium. The term “non-transitory” may indicate that the storage medium is not embodied in a carrier wave or a propagated signal. However, the term “non-transitory” shall not be interpreted that the memory 1140 is non-movable.

The at least one processor 1120 may process data stored in the memory 1140. The at least one processor 1120 may execute computer-readable code (e.g., software) stored in the memory 1140 and instructions triggered by the at least one processor 1120.

The at least one processor 1120 may be a data processing device implemented as hardware including a circuit having a physical structure to perform desired operations. For example, the desired operations may include code or instructions included in a program.

For example, the hardware-implemented data processing device may include a microprocessor, a CPU, a processor core, a multi-core processor, a multiprocessor, an ASIC, or an FPGA.

The at least one processor 1120 may include a variety of processing circuitry and/or a plurality of processors. For example, as used in the present disclosure and claims, the term “processor” may include a variety of processing circuitry including at least one processor, and one or more of the at least one processor may be configured to individually or collectively perform various functions described herein. When the present disclosure describes that the “processor”, “at least one processor”, or “one or more processors” are configured to perform various functions, these terms may include, for example, a case in which one processor performs some of the described functions and the other processors perform other functions, as well as a case in which a single processor performs all of the described functions. The at least one processor may be a combination of processors for performing the described or disclosed functions collectively. The at least one processor may execute a program instruction to achieve or perform various functions.

For example, the at least one processor 1120 may include a main processor (e.g., a CPU or an application processor) and an auxiliary processor (e.g., a communication processor, an NPU, and/or a GPU).

The at least one processor 1120 may cause the image translation device 1100 to perform operations performed during the training process or the inference process described herein by individually or collectively executing the code, instructions, and/or applications stored in the memory 1140.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Although the disclosure has been illustrated and explained with reference to various embodiments, it will be understood by those skilled in the art that the various embodiments are intended to be illustrative but not restrictive. It will be understood by those skilled in the art that various changes in forms and details may be made without departing from the true spirit and full scope of this disclosure including the scope of the attached claims and their equivalents. Also, it will be understood by those skilled in the art that any of the embodiments described herein may be used in other embodiments described herein. Accordingly, other conjunction with other implementations are within the scope of the following claims.

The effects to be achieved are not limited to those described above, and other effects not mentioned above will be clearly understood by one of ordinary skill in the art from this document.

It shall be understood that the present disclosure is described and illustrated with reference to various embodiments, but the embodiments are examples and not limiting. In addition, those skilled in the art will understand that various modifications, alternatives, and/or variations of the embodiments disclosed in the present disclosure are performed without departing from the true technical idea and the overall technical scope defined by the attached claims and equivalents. Furthermore, it shall be understood that one or more embodiments described herein are combined with other embodiments described herein.

1. A method of translating an image, the method comprising:
generating a synthetic aperture radar (SAR) latent feature by encoding an SAR image of a target region;
generating an initial latent feature for denoising by adding noise to the SAR latent feature;
generating an additional conditioning latent feature that provides structural guide information of the target region by encoding additional conditioning data comprising map data that provides spatial information about the target region;
generating a text latent feature by encoding text information that provides at least one of temporal information of the SAR image, spatial information of the SAR image and
the description that a type of an image to be generated from the SAR image is an electro-optical (EO) image type;
generating an image description latent feature by encoding at least one of information related to the SAR image and information related to an EO image to be generated from the SAR image;
generating an EO latent feature of the EO image by performing denoising on the initial latent feature using the SAR latent feature, the text latent feature, the additional conditioning latent feature, and the image description latent feature; and
generating the EO image by decoding the EO latent feature.

2. The method of claim 1,
wherein the additional conditioning data further comprises:
at least one of digital elevation model (DEM) data corresponding to the SAR image, digital surface model (DSM) data corresponding to the SAR image, and land cover map data corresponding to the SAR image.

3. The method of claim 1,
wherein the first text information is obtained by analyzing the SAR image using a vision-language model (VLM).

4. The method of claim 1,
wherein the generating of the EO latent feature comprises:
performing the denoising on the initial latent feature based on a number of inference time steps indicating an iteration count of denoising tasks to be applied to generate the EO latent feature from the initial latent feature.

5. The method of claim 4,
wherein the performing of the denoising on the initial latent feature based on the number of inference time steps comprises:
performing the denoising on the initial latent feature based on an inference time scheduler that determines a sequence of discrete time steps selected based on the number of inference time steps from pre-trained diffusion stages.

6. The method of claim 1,
wherein the information related to the SAR image comprises:
at least one of capture condition information of the SAR image, a capture time of the SAR image, and pixel information of the SAR image, wherein the pixel information of the SAR image comprises at least one of a ground sample distance (GSD), latitude, and longitude of each pixel,
the information related to the EO image comprises:
at least one of style information of the EO image, a GSD of a pixel of the EO image, and temporal context information of the EO image.

7. An apparatus for translating an image, the apparatus comprising:
at least one processor; and
at least one memory storing instructions,
wherein the instructions, when executed individually or collectively by the at least one processor, cause the apparatus to perform a plurality of operations comprising:
generating a synthetic aperture radar (SAR) latent feature by encoding an SAR image of a target region;
generating an initial latent feature for denoising by adding noise to the SAR latent feature;
generating an additional conditioning latent feature that provides structural guide information of the target region by encoding additional conditioning data comprising map data that provides spatial information about the target region;
generating a first text latent feature by encoding first text information that provides at least one of temporal information of the SAR image and spatial information of the SAR image, and
the description that a type of an image to be generated from the SAR image is an electro-optical (EO) image type;
generating an image description latent feature by encoding at least one of information related to the SAR image and information related to an EO image to be
generated from the SAR image;
generating an EO latent feature of the EO image by performing denoising on the initial latent feature using the SAR latent feature, the first text latent feature, the additional conditioning latent feature, and the image description latent feature; and
generating the EO image by decoding the EO latent feature.

8. A method of training an image translation model, the method comprising:
generating an electro-optical (EO) latent feature comprising feature information of an EO image that is a ground truth image by encoding the EO image;
generating a noisy EO latent feature by adding noise to the EO latent feature;
generating a synthetic aperture radar (SAR) latent feature by encoding an SAR image corresponding to the EO image;
generating an additional conditioning latent feature that provides structural guide information of a target region represented in the SAR image by encoding additional conditioning data comprising map data of the target region;
generating a text latent feature by encoding a text prompt that provides at least one of temporal information of the SAR image and spatial information of the SAR image;
by using a denoising model, generating predicted noise corresponding to the noise, and a confidence map having a lower dimension than a dimension of the EO image based on the SAR latent feature, the noisy EO latent feature, the additional conditioning latent feature, and the text latent feature; and
updating parameters of the denoising model using the confidence map as a weight for an error between the noise and the predicted noise,
wherein the confidence map provides weighting information about at least one of a temporal mismatch and a spatial mismatch among the EO image, the SAR image, and the additional conditioning data.

9. The method of claim 8,
wherein the updating of the parameters of the denoising model comprises:
updating the parameters so that the predicted noise becomes closer to the noise.

10. The method of claim 9,
wherein the updating of the parameters so that the predicted noise becomes close to the noise comprises:
updating the parameters to minimize a value of a loss function for calculating a total loss corresponding to the confidence map using an individual loss of each pixel of the confidence map.

11. The method of claim 8,
wherein the generating of the predicted noise and the confidence map comprises:
generating the predicted noise and the confidence map from the SAR latent feature, the noisy EO latent feature, the additional conditioning latent feature, and the text latent feature based on a time step that provides information about a level of the noise added to the EO latent feature.
